(19) United States
(12) Patent Application Publication
(10) Pub. No.: US 2002/0155062 A1
(43) Pub. Date: Oct. 24, 2002

(54) Production of hydrogren from biomass

(76) Inventor: Gene E. Lightner, Federal Way, WA (US)

Correspondence Address: Gene E. Lightner, 706 SW 296 St, Federal Way, WA, 98023, US

(21) Appl. No.: 09/841,504

(22) Filed: Apr. 24, 2001

(51) Int. Cl. C01B 3/26

(52) U.S. Cl. 423/652

(57) ABSTRACT

Partial oxidation of a biomass is employed to provide producer gas followed by complete combustion of resulting solid remains from partial oxidation to provide a flue gas to furnish heat for the method. Producer gas is subjected to a steam reforming catalyst provided by heat from the flue gas for reforming of hydrocarbons contained in the producer gas to produce hydrogen and carbon monoxide. Following reforming, the gas, containing water vapor, is subjected to a steam shifting catalyst provided by heat from the flue gas to replace endothermic heat required to produce hydrogen and carbon dioxide. Remaining residue from combustion of the biomass is subjected to heat exchange to heat air for combustion. Shifted gas, containing substantial sensible heat, is employed to transfer heat to air and furnish heated air for partial oxidation.

### BACKGROUND OF THE INVENTION

There is an increasing interest in converting renewable biomass to usable products to avoid consumption of non-replaceable fossil fuels. Biomass is associated with non-fossil organic materials that contain fundamental energy derived from the sun. A biomass is often selected from the group consisting of wood, waste paper and municipal solid waste including an individual or a combination of these materials

Partial oxidation of a biomass is employed to generate a producer gas. Resulting producer gas contains carbon monoxide, hydrogen, and methane and is often used to furnish a fuel to supply energy to an engine or a boiler. Air is provided as needed to maintain partial oxidation of the biomass.

Manufacture of producer gas, is described in Chemical Engineers Handbook third edition, edited by John H Perry, page 1579. The process begins by blowing humidified air into a deep ignited bed of solid fuel usually coal or coke to form an incandescent bed of carbon. The bed of carbon reacts with oxygen in the air to create carbon dioxide which reacts with carbon to form carbon monoxide.

Water vapor, contained in the air, partly reacts with carbon monoxide to form carbon dioxide and hydrogen. The resulting gas contains carbon monoxide, carbon dioxide, hydrogen and nitrogen. .

It is therefore an object of this invention to obviate many of the limitations of the prior art.

A principal object of this invention is to produce hydrogen from a biomass.

A distinct object of this invention is by partial combustion of a biomass to create producer gas.

A further fundamental object of this invention is to provide complete combustion of biomass subjected to partial combustion of a biomass and provide a flue gas..

A fundamental object of this invention is to utilize thermal energy from flue gas to supply heat to compensate energy for endothermic reactions..

An object of this invention is.to remove sensible heat from flue gas to supply heat for reactions and remove moisture from a biomass wherein a biomass of reduced moisture is provided

Another object of this invention is to store hydrogen produced by biomass.

An additional object of this invention is.to remove sensible heat from flue gas to supply heat for reactions and remove moisture from a biomass wherein a biomass of reduced moisture is provided for partial combustion.

With the above and other objects in view, this invention relates to the novel features and alternatives and combinations presently described in the brief description of the invention.

### THEORETICAL BACKGROUND OF THE INVENTION

Producer gas, containing carbon monoxide, water vapor, volatile hydrocarbons and methane is subjected to a steam reforming catalyst to convert volatile hydrocarbons and methane to hydrogen and carbon monoxide. The resulting gas, containing water vapor and carbon monoxide, is subjected to a steam shifting catalyst to convert carbon monoxide and water vapor to hydrogen and carbon dioxide. Both catalytic procedures are applied in the present invention and are presented in Chemical Process Industries, second edition, authored by R. N. Shreve. Within page 135, a steam hydrocarbon process for a propane catalytic reaction is presented by the chemical formula, C₃H₃+3H₂O [symbol] 2CO₂+H₂. Any hydrocarbon, including methane, will be reversibly reformed from water vapor to form hydrogen and carbon monoxide

Catalytic reaction to shift water vapor and carbon monoxide is portrayed by Shreve op. cit., page 136, presented by the chemical formula, CO+H₂O [symbol] CO₂+H₂.. Thus hydrogen and carbon dioxide are reversibly formed from water vapor from carbon monoxide and water vapor. These reactions are endothermic and require energy from an external source to maintain temperature within the respective catalyst. Sensible heat from flue gas will supply energy to maintain temperature of the special catalyst. Flue gas, of reduced sensible heat, is employed in a dryer to remove water from a biomass and concluding in a flue gas for release to the atmosphere.

Producer gas is provided by partial combustion of biomass and provides a remainder subject to complete combustion by air to provide flue gas and a residue of thermal energy. The residue is subjected to heat exchange to heat the air used for combustion of the remainder and provides a residue of reduced temperature. Gases from the catalysts, containing sensible heat, are subjected to heat exchange to heat the air used for partial combustion and the gas is of reduced heat. Accordingly energy is consumed to provide gases containing hydrogen.

### BRIEF DESCRIPTION OF THE INVENTION

The present invention in its broadest aspect, establishes a method to produce a gas containing hydrogen derived from a biomass. Producer gas containing water vapor, hydrocarbons, and carbon monoxide is derived by partial combustion of a biomass. Complete combustion of remains from partial combustion is utilized to form flue gas and a residue containing inorganic solids. The residue is subjected to heat exchange to heat air for combustion and result in a residue of gas of diminished sensible heat. Producer gas is subjected to a catalyst for steam reforming and subjected to a catalyst for steam shifting gas derived from steam reforming. Thus carbon monoxide is reacted with water vapor to form hydrogen and carbon dioxide. These catalyzed reactions are both endothermic. Energy for both catalyzed reactions is obtained by heat from flue gas accomplished by combustion. Sensible heat contained in a gaseous mixture from catalyzed reactions is subjected to a heat exchanger to transfer heat to air utilized for partial combustion and producing a gaseous mixture of reduced sensible heat thereby producing a gas containing hydrogen derived from a biomass.

Characteristics of the invention include:

Producer gas is derived from partial combustion of a biomass.

Complete combustion of remains from partial combustion is performed by heated air.

Flue gas is employed to replace heat of endothermic reactions.

Hydrogen is obtained by catalytic reactions of a producer gas

Moisture content of a biomass is reduced by a dryer supplied from a flue gas

Energy released from a biomass combustion is substantially consumed in the method.

The gas containing hydrogen, derived from a biomass, is separated from the gas to produce hydrogen substantially devoid of impurities.

The method is generally continuous.

Hydrogen contained in a gas may be is stored in a medium and separated from the gas for release.

Air is supplied to maintain a heat balance within the method

Hydrogen, derived from a biomass, generally provides energy to operate a fuel cell.

### BRIEF DESCRIPTION OF THE DRAWINGS

The features that are considered characteristic of this invention are set forth in the appended claims. This invention, however, both as to its origination and method of operations as well as additional advantages will best be understood from the following description when read in conjunction with the accompanying drawings in which:

FIG. 1 is a flow sheet denoting the invention as set forth in the appended claims.

FIG. 2 is a flow sheet denoting a method to remove water from a biomass.

FIG. 3 is a flow sheet denoting a method to store hydrogen in a medium.

FIG. 4 is a flow sheet denoting a method to separate hydrogen with a membrane.

### DETAILED DESCRIPTION OF THE PREFERRED EMBODIMENT

In the preferred embodiment of the present invention production of hydrogen derived from a supplied biomass is presented. Producer gas, by catalytic essential changes, provide hydrogen and carbon dioxide.

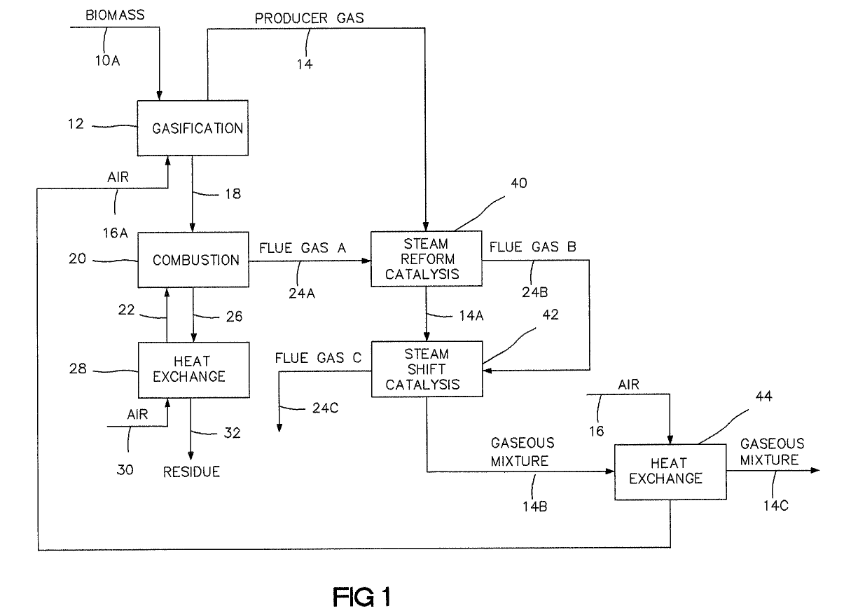

The flow diagram of FIG. 1 illustrates the general preferred embodiment of the present invention. In the diagram, rectangles represent stages, operations or functions of the present invention and nonessential separate components. Arrows indicate direction of flow of material in the method.

Referring to FIG. 1, biomass 10A is conveyed to gasification stage 12 to furnish producer gas 14, containing carbon monoxide, by partial combustion with air 16A. Remaining solids from partial combustion 18 are contained in combustion stage 20 and are subject to complete combustion by heated air 22 to form flue gas 24A and residue 26 which is subjected to heat exchange stage 28 to heat air 30 and provide residue 32 of reduced temperature. Flue gas 24A is transported to steam reform catalysis stage 40 which is utilized to provide energy to producer gas, containing carbon monoxide, 14 to provide reformed gas, containing carbon monoxide and water vapor, 14A and transported to steam shift catalysis stage 42 to produce a gaseous mixture 14B containing hydrogen and carbon dioxide which is conveyed to heat exchange stage 44 to heat air 16 and furnish heated air 16A to gasification stage 12 and supply gaseous mixture 14C of reduced sensible heat. Flue gas 24A, transported to steam reform catalysis stage 40, is prevented from contacting producer gas by means of a heat transfer device, unobserved within the drawing, which provides heat for endothermic reactions and flue gas B 24B of reduced sensible heat.

Similarly, flue gas B 24B is transported to steam shift catalysis stage 42, to transfer heat from flue gas B 24B and generate flue gas C 24C of reduced sensible heat and produce gaseous mixture 14B. Residue 26 can remain within combustion stage 20 for heating of air thus requiring an unnecessary heat exchange stage 28 to provide heat air 30. Flue gas A 24A is essential to the method to replace endothermic heat of both catalytic reactions. Complete combustion by heated air 22 is required to form a sufficient quantify of flue gas. The remaining solids from partial combustion 18 may be contained in a single vessel for combustion within combustion stage 20 with separate outlets for producer gas 14 and flue gas 24A.

Referring to FIG. 2, flue gas C 24C is conveyed to biomass dryer stage 46 to provide heat to supplied biomass 10 to remove water and provide biomass of reduced water 10A and flue gas D 24D of insubstantial reduced sensible heat to be discarded.

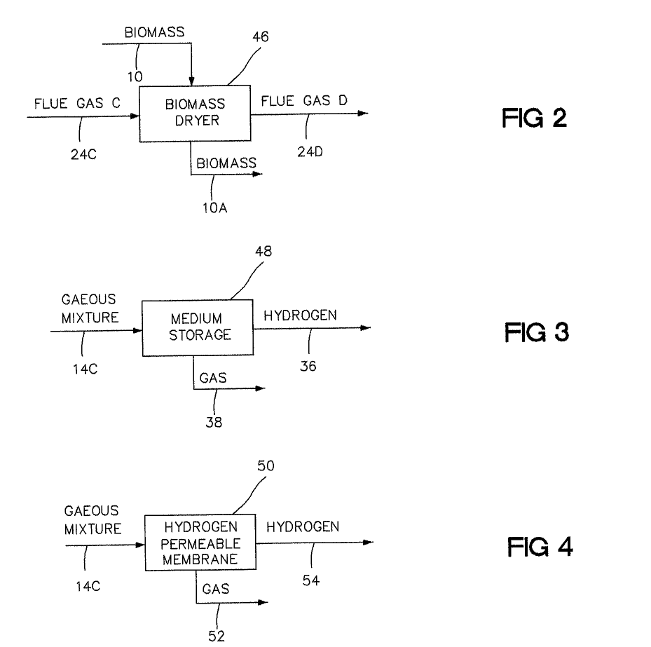

Referring to FIG. 3, gaseous mixture 14C containing hydrogen and carbon dioxide is conveyed to medium storage 48 to store hydrogen within the medium contained within medium storage 48. Upon storage, hydrogen 36 is released from storage. Gas 38, not stored within the medium, is separated from the medium for subsequent treatment for ultimate disposal.

Referring to FIG. 4, gaseous mixture 14C containing hydrogen and carbon dioxide is conveyed to hydrogen permeable membrane 50 to allow advance of hydrogen 54. Gas 52, un-permeated by the hydrogen permeable membrane, is separated from the hydrogen permeable membrane.

What is claimed is:

1. A method to produce hydrogen from a gas containing water vapor, hydrocarbons, and carbon monoxide, which comprises:
providing a gas containing water vapor and carbon monoxide derived from a biomass, and
providing a flue gas by means of combustion of a biomass, and
providing a catalyst for steam reforming said gas containing hydrocarbons, and
providing a catalyst for steam shifting gas derived from steam reforming containing carbon monoxide, and
subjecting said gas containing water vapor, hydrocarbons, and carbon monoxide to said catalyst for steam reforming to form hydrogen and carbon monoxide, and
subjecting gas following steam reforming containing water vapor and carbon monoxide to said catalyst for steam shifting to form hydrogen and carbon dioxide, and
thereby producing a gas containing hydrogen derived from a biomass.

2. The method of claim 1 wherein said gas containing water vapor, hydrocarbons, and carbon monoxide is subjected to said catalyst for steam reforming to form gaseous hydrogen and carbon monoxide.

3. The method of claim 2 wherein the gaseous hydrogen and carbon monoxide is subjected to said catalyst for steam shifting to form a gas containing hydrogen and carbon dioxide.

4. The method of claim 1 wherein the gas containing water vapor, hydrocarbons, and carbon monoxide is obtained from partial oxidation of a biomass.to create solid remains.

5. The method of claim 4 wherein the remains are subjected to combustion by air to create a flue gas and a residue containing inorganic solids.

6. The method of claim 5 wherein the residue containing inorganic solids is used to heat air for combustion and produce a residue containing inorganic solids of reduced sensible heat.

7. The method of claim 5 wherein the flue gas is used to supply heat to replace exothermic heat to catalysts for steam reforming and steam shifting and produce flue gas of diminished sensible heat.

8. The method of claim 7 wherein the flue gas, of diminished sensible heat, is utilized within a dryer to remove water from a biomass and produce flue gas to be discarded.

9. The method of claim 1 wherein the method is continuous.

10. The method of claim 1 wherein said gas containing hydrogen, derived from a biomass, is separated from the gas to produce hydrogen substantially devoid of impurities.

11. The method of claim 1 wherein said gas containing hydrogen, derived from a biomass, is separated from the gas in a medium to store hydrogen for release.

12. The method of claim 4 wherein the biomass is selected from the group consisting of wood, waste paper and municipal solid waste including an individual or a combination of these materials thereof

13. The method of claim 1 wherein said gas containing hydrogen, derived from a biomass, provides energy to operate a fuel cell.

14. The method of claim 1 wherein said combustion is supplied by air to maintain a heat balance within the method.

15. The method of claim 1 wherein said water vapor is supplied from moisture contained within a biomass.
